(19) United States
(12) Patent Application Publication
(10) Pub. No.: US 2007/0176447 A1
(43) Pub. Date: Aug. 2, 2007

(54) Truck rack having replaceable decorative inserts

(75) Inventors: Ron Storer, Villa Park, CA (US); Peter Kekich JR., Palm Desert, CA (US); David J. Ward, Corona, CA (US)

Correspondence Address: STETINA BRUNDA GARRED & BRUCKER, 75 ENTERPRISE, SUITE 250, ALISO VIEJO, CA, 92656, US

(73) Assignee: Xtreme Metal Fab., Inc.

(21) Appl. No.: 11/342,890

(22) Filed: Jan. 30, 2006

(51) Int. Cl. B60P 3/00

(52) U.S. Cl. 296/3

(57) ABSTRACT

A customizable truck rack is provided that is mountable to a cargo bed of a vehicle, which cargo bed includes opposing side walls. The rack comprises: at least one decorative insert; opposing vertical members, whose bottom ends may be mounted to the side walls; and a horizontal member that is attachable intermediate top ends of the vertical members. The insert defines a peripheral edge and includes a decorative face. The vertical members each include an insert bay that is sized and configured to secure at least a portion of the peripheral edge of the insert thereto. Further, at least a portion of the decorative face of the insert is exposed upon being secured to the insert bay.

### CROSS-REFERENCE TO RELATED APPLICATIONS

The present application claims priority to: U.S. application Ser. No. 11/203,737 filed on Aug. 15, 2005; U.S. application Ser. No. 10/770,214 filed on Feb. 2, 2004; and to U.S. Design Pat. No. D493,414, filed on May 8, 2003.

### STATEMENT RE: FEDERALLY SPONSORED RESEARCH/DEVELOPMENT

Not Applicable

### BACKGROUND

The present invention relates generally to a truck sport rack, and more particularly, to a customizable truck rack having uniquely configured vertical support members whereon decorative inserts may be interchangeably mounted.

Various types of truck racks have been developed for the general purposes of either protecting goods carried in a cargo bed of the truck or for providing structural strength in the event of a vehicle rollover. In most cases, the truck rack includes a frame member that is attached to the cargo bed of the truck and extends upwardly around a cabin of the truck, generally following the aerodynamic contours of the cabin. In this regard, a first general configuration of the truck rack usually includes mounting the frame member toward the middle of the truck. In another configuration, the rack may include another frame member mounted at the rear of the truck with side bar members interposed between the frame members, resulting in a rack that spans the entire length of the cargo bed. Various modifications to these two configurations have been developed. Typically however, the frame members are composed of hollow, cylindrical metal tubing that is bent and formed in a generally u-shape.

One of the drawbacks associated with the various configurations of current truck racks is the owner's inability to alter or modify the truck rack after installation. Although a sturdy, reliable truck rack is desirable, truck racks that are permanently mounted to the cargo bed of a truck, or that require some type of physical alteration to the truck bed such as cutting or welding, both require the truck owner to make a long term decision regarding the truck rack. In this sense, the truck owner must be completely satisfied with the design of the truck rack, or be required to cope with any resultant damage to the cargo bed should the owner wish to uninstall or modify the truck rack.

In fact, it appears that truck owners may be quite interested in a truck rack that provides them with greater flexibility to alter the design or look of the truck rack as desired. Truck owners may be especially interested if such alterations do not require the owner to make significant changes, such as removing an old rack to install a new rack, modifying the cargo bed, or altering the rack to accommodate new accessories.

Therefore, there is a need in the art for a truck rack that may be easily modified to take on a new look and design, as desired by the owner. There is a need in the art for a truck rack that is structurally sound and provides the owner with a variety of options as to accessories and other components that may be utilized in conjunction with the truck rack. Finally, there is a need in the art for an innovative truck rack that may be easily mounted to a truck cargo bed without causing significant alteration to the truck and that may be modified periodically according to the tastes and preferences of the owner without requiring the significant changes to the truck rack itself.

### BRIEF SUMMARY

In accordance with an embodiment of the present invention, a decorative insert for a customizable truck rack is provided. The rack may be used on any variety of vehicles, especially trucks, which include a cargo bed with opposing side walls. The rack includes opposing vertical support members and a horizontal crossbar member. The vertical support members define bottom and top ends, with the bottom ends being attachable to opposing side walls of a cargo bed of a vehicle, and the horizontal crossbar member being attachable to the top ends of the vertical support members. Thus, the rack may be modular; however, it may also be of unitary construction.

The vertical support members used in embodiments of the present invention each include a body which defines the bottom and top ends, as mentioned above. Further, the vertical support members also each include an insert bay that is disposed in the body of the vertical support member.

The insert is preferably formed from a sheet and defines a peripheral edge and a decorative face. In this regard, the insert bay is sized and configured to receive at least a portion of the decorative insert for cooperatively securing the insert thereto. Thus, the insert is positionable on the insert bay with the decorative face being exposed.

In certain implementations of the present invention, the insert bay may be sized and configured to receive the entire decorative insert secured therein. Further, the insert bay may include an aperture which defines an interior perimeter edge. The insert bay may also define inner and outer surfaces. In this regard, the insert bay may be configured to secure the decorative insert adjacent the inner surface with a decorative face of the insert being exposed through the aperture.

In addition, the vertical support member may also include a gasket element that is disposable about the interior perimeter edge of the aperture of the insert bay. The gasket element may provide for various structural and mechanical advantages, such as eliminating rattling between the insert and the insert bay, as well as providing unique aesthetic properties.

In addition, the insert bay may further include at least one bay fastener hole. The bay fastener hole may be sized and configured to receive a fastener therethrough. In this regard, the insert may also includes at least one insert fastener hole corresponding to a respective bay fastener hole. The insert fastener hole may also be sized and configured to receive a fastener therethrough for securing at least a portion of the insert to the insert bay.

According to an embodiment of the present invention, the insert may be substantially planar. Further, the decorative face of the insert may include a structural pattern. The pattern may include any variety of designs. For example, the pattern may be centrally disposed on the decorative face of the insert and may be a cut-out from the insert.

Indeed, one of the unique advantages of embodiments of the present invention is that the insert may be replaceably mounted to the insert bay of the vertical support as desired. Further, the entire rack may be of modular construction, which allows the rack to be easily shipped and installed. These advantages, among others, will be presented in further detail below.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a rear perspective view of a customizable truck rack having opposing vertical support members, a horizontal crossbar member, and decorative inserts according to an aspect of the present invention;

FIG. 2 is a top plan view thereof;

FIG. 3 is a partial section view of FIG. 2 showing an inner surface of an insert bay disposed on the vertical support member and the securement of the insert thereto, according to an aspect of the present invention;

FIG. 4 is a left side view of the truck rack illustrating the alignment of insert and bay fastener holes in order to secure the insert to the insert bay, the dotted lines solely depicting alignment thereof and forming no part of the claimed design;

FIG. 5 is a perspective end elevational view of an exemplary insert secured to the insert bay, according to a further aspect of the present invention;

FIG. 5a is a side view of an exemplary insert incorporating a structural pattern according to an embodiment of the present invention;

FIG. 6 is a perspective end elevational view of another exemplary insert secured to the insert bay, according to a further aspect of the present invention;

FIG. 6a is a side view of another exemplary insert incorporating a structural pattern according to an embodiment of the present invention;

FIG. 7 is a perspective end elevational view of another exemplary insert secured to the insert bay, according to a further aspect of the present invention;

FIG. 7a is a side view of another exemplary insert incorporating a structural pattern according to an embodiment of the present invention;

FIG. 8 is a perspective end elevational view of yet another exemplary insert secured to the insert bay, according to a further aspect of the present invention; and

FIG. 8a is a side view of yet another exemplary insert incorporating a structural pattern according to an embodiment of the present invention.

### DETAILED DESCRIPTION

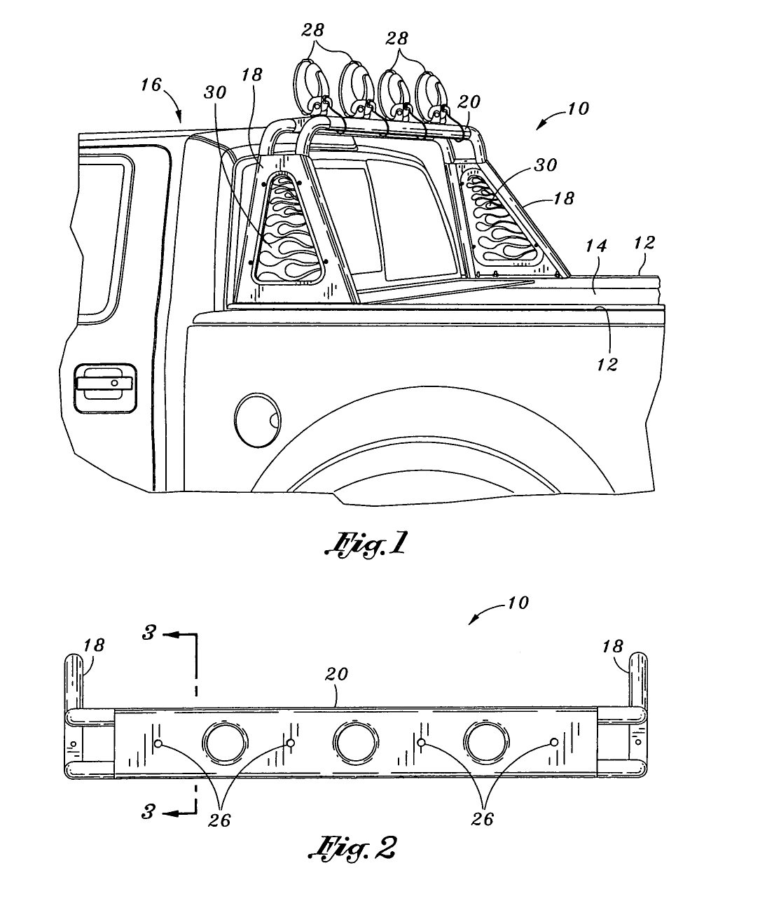

Referring now to the drawings wherein the showings are made for purposes of illustrating preferred embodiments of the present invention, and not for purposes of limiting the same, FIG. 1 is an exemplary embodiment of a customizable truck rack 10. U.S. patent application Ser. No. 11/203,737 filed on Aug. 15, 2005, U.S. patent application Ser. No. 10/770,214 filed on Feb. 2, 2004, and U.S. Design Pat. No. D493,414, filed on May 8, 2003, which are herein incorporated by reference, also illustrate exemplary truck rack designs, with which teachings of the present invention may also be utilized. As shown in FIG. 1, the rack 10 may be mountable to a cargo bed 14 of a vehicle 16. The rack 10 may be of modular construction in order to allow the rack 10 to be mounted onto a wide variety of vehicle 16 that have cargo beds 14 of varying geometry. Alternatively, as discussed below, the rack 10 may also be of unitary construction.

The rack 10 includes opposing vertical support members 18 and a horizontal crossbar member 20. The vertical support members 18 define bottom and top ends 22, 24. The bottom ends 22 are attachable to the opposing side walls 12 of the cargo bed 14 of the vehicle 16. The vertical support members 18 are preferably fabricated from metal, as detailed below; however, any material with appropriate strength characteristics may be used.

The horizontal crossbar member 20 is attachable to the top ends 24 of the vertical support members 18. The horizontal crossbar member 20, similarly to the vertical support members 18, is also preferably fabricated from metal, as also detailed below; however, any material with appropriate strength characteristics may be used. In addition, as shown in FIGS. 1 and 2, the horizontal crossbar member 20 may be modified to include mounting positions 26 to accommodate accessories 28 such as the lights shown in FIG. 1.

As illustrated in FIGS. 1 and 2, the attachment of the vertical support members 18 to the horizontal crossbar member 20 result in a truck rack 10 that may provide significant structural as well as aesthetic benefits to a truck owner. As discussed in the patent applications mentioned above, the unique modular design of the truck rack 10 allows for easy installation onto the cargo bed 14 of the vehicle 16. Further, the heavy-duty configuration of the truck rack 10 provides for strength and durability.

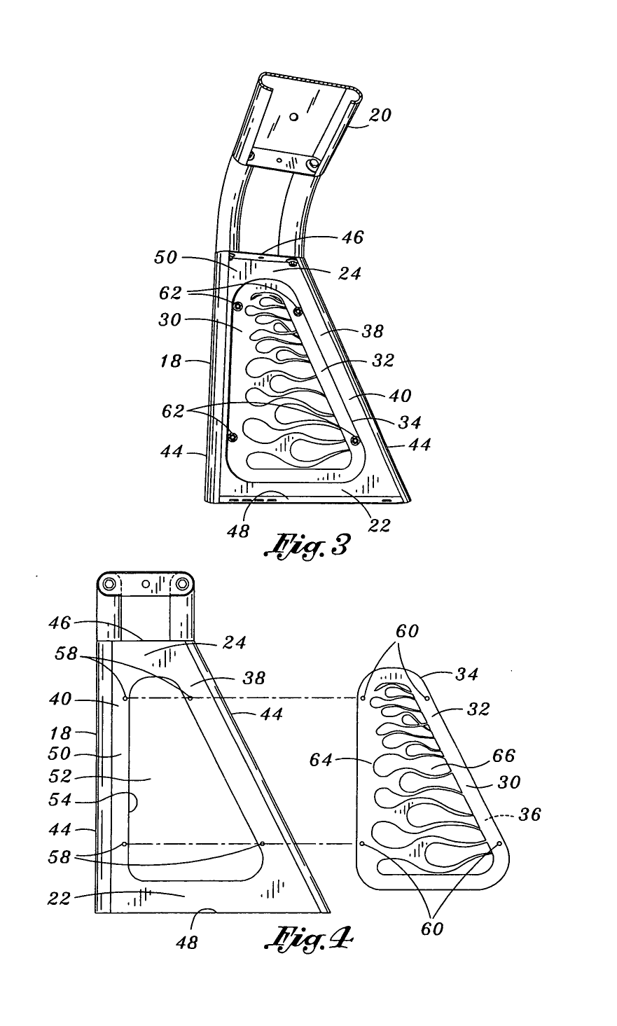

Referring now to FIGS. 3 and 4, the truck rack 10 also includes at least one decorative insert 30. The insert 30 is preferably formed as a sheet 32, which may be fabricated from various materials, such as metal, plastic, composites, etc., also discussed below. The sheet 32 defines a peripheral edge 34 and includes a decorative face 36. As will be discussed further herein, the versatility, ease of installation, and numerous aesthetic benefits of the decorative insert 30 provides embodiments of the present invention with distinct and unique advantages over various prior art truck racks.

In an embodiment shown in FIG. 4, the vertical support member 18 preferably includes a body 50. As illustrated in FIGS. 3 and 4, the vertical support members 18 are also configured to include an insert bay 38. The insert bay 38 is sized and configured to secure at least a portion of the peripheral edge 34 of the insert 30 thereto. Thus, the insert bay 38 may be defined as that portion of the vertical support member 18 that is adapted to secure at least a portion of the peripheral edge 34 of the insert 30. The insert bay 38 may be able to secure the entire insert 30 thereto, or may secure only a portion thereof. In some implementations, it is contemplated that the insert bay 38 may be configured to contact the insert 30 about the entire peripheral edge 34 thereof. However, in other implementations, it is contemplated that only select portions, such as opposing sides or top and bottom portions of the peripheral edge 34 may be contacted by the insert bay 38 in order to properly secure the insert 30 thereto.

The insert bay 38 may define inner and outer surfaces 40, 42, which are respectively shown in FIGS. 3 and 1. Indeed, the insert bay 38 may be integrally formed in the body 50 of the vertical support 18, such as being unitarily formed therewith out of a continuous piece of material. For example, the insert bay 38 may be unitarily formed with the vertical support member 18 and be a portion of the body 50 thereof, such as an indentation or recess that receives at least a portion of the peripheral edge 34 of the decorative insert 30. Thus, the insert bay 38 may be a recess within the body 50 of the vertical member 18 that is sized and configured to receive the insert 30 on the outer surface 42 thereof. However, it is also contemplated that the insert bay 38 may be separate from and attachable to the vertical support 18. In either case, as shown in FIG. 1, upon being secured to the insert bay 38, at least a portion of the decorative face 36 of the insert 30 should be exposed so as to be visually perceptible by the user and other individuals.

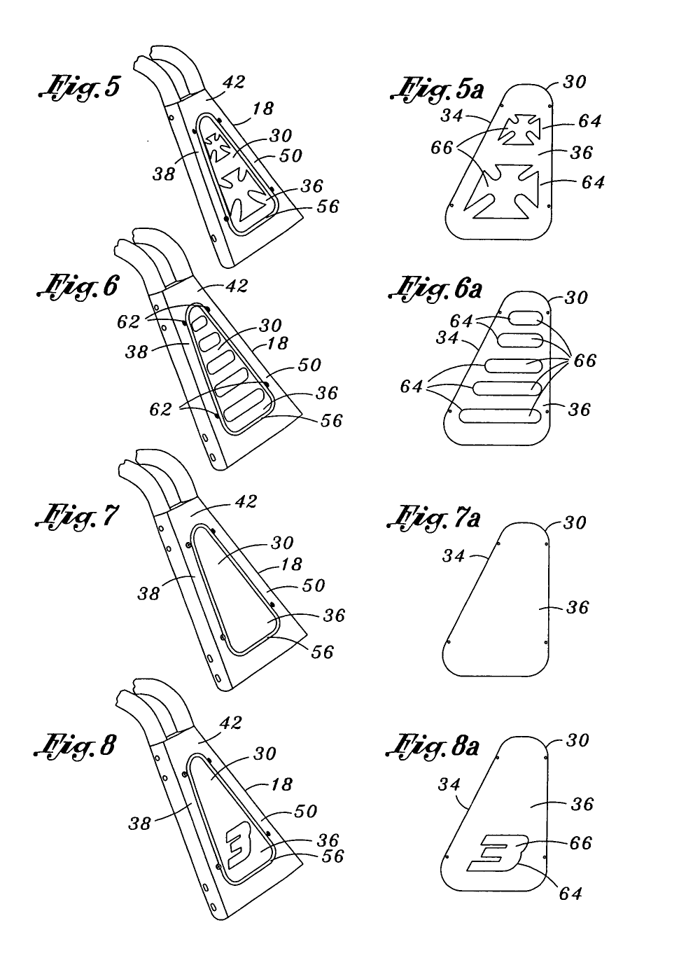

As mentioned above, the insert bay 38 may be formed unitarily with the vertical support member 18. Thus, FIGS. 1, 3, 4, 5, 6, 7, and 8 illustrate such an exemplary embodiment of the vertical support member 18 with the insert bay 38 being formed unitarily therewith. As shown therein, the vertical support member 18 may be generally formed using a single sheet 32 of material that is curved at opposing side edges 44 with the opposing side edges 44 being bent inwardly toward each other. The opposing side edges 44 may therefore provide stiffness, rigidity, and structural strength to the single sheet 32 of material used to fabricate the vertical support member 18.

Further, as shown in FIG. 3, the structural support member may include upper and lower flanges 46, 48 disposed respectively at the top and bottom ends 24, 22 of the vertical support member 18. These upper and lower flanges 46, 48 may be utilized to attach the vertical support member 18 to the horizontal crossbar member 20 and to the side walls 12 of the cargo bed 14. This configuration and capability may therefore allow the vertical support member 18, and indeed the rack 10 in general, to be modular and easy to ship and transport. As indicated herein and in the above-referenced U.S. Patent Applications, the rack 10 may thus be easily assembled from the components provided. As will be appreciated, various other designs and configurations of the vertical support member 18 may be utilized without departing from a scope of embodiments of the present invention presented herein.

For example, the vertical support member 18 may include a single or multiple bars of various cross sections that may be attachable to the horizontal crossbar member 20 and to the opposing side walls 12. Of particular importance, the vertical support members 18 should be able to include the insert bay 38 in order to properly secure the decorative inserts 30 to the vertical support members 18. As described above, the insert bay 38 may be unitarily formed into the vertical support member 18 or formed separately and attached thereto. Thus, the insert bay 38 in such an implementation may be attached to the vertical support member 18 by use of straps, clamps, or other fasteners.

The insert bay 38 may also be retrofittable onto existing truck racks 10. Furthermore, the opposing vertical support members 18 (as well as the insert bays 38) and the horizontal crossbar member 20 may be either modular or unitarily formed. Thus, although it may be preferable to have a modular rack, which offers the benefit of easier shipping and installation, the vertical support members 18 and the horizontal crossbar member 20 may be fabricated from at least one substantially continuous piece of material that simultaneously attaches to both of the opposing side walls 12 of the cargo bed 14.

According to another exemplary embodiment, shown in FIG. 4, the insert bay 38 may include at least one aperture 52. The aperture 52 may be formed into the insert bay 38 by a manufacturing process such as punching, cutting, or casting the insert bay 38 or vertical support, just to name a few. The aperture 52 defines an interior perimeter edge 54. Although illustrated as being substantially formed as a parallelogram, the aperture 52 may be of any size, configuration, and/or shape. In this regard, it is contemplated that the configuration of the aperture 52 may correspond to properties of the decorative insert 30 such as the size, shape, and decorative face 36 of the insert 30.

Referring again to FIG. 1, it is also contemplated that the insert bay 38 may also include a gasket element 56 that is disposable about the interior perimeter edge 54 of the aperture 52 of the insert bay 38. The gasket element 56 may be made of plastic, rubber, or other material exhibiting desirable properties. For example, the gasket element 56 may be advantageously used to eliminate any rattling or other noise that may otherwise be produced due to the interaction of the insert 30 with the insert bay 38. Such noise may commonly be made given the normally uneven texture of streets, which may possibly result in a rattling sound. Further, it is also possible that the airflow around the rack 10 may result in a whistling noise due to the union of the insert 30 at the insert bay 38.

Other advantages of using the gasket element 56 may be purely aesthetic. For example, the gasket element 56 may be a particular color or incorporate a certain texture that is desirable to the owner. The owner may thus customize his or her rack 10 with a gasket element 56 that matches the color of the vehicle, be it black, white, pink, silver, or otherwise. The gasket element 56 may therefore serve to provide yet another customizable feature to the rack 10 according to an implementation of the present invention.

As illustrated in FIG. 4, the insert bay 38 is further preferably configured to include at least one bay fastener hole 58. In this regard, the bay fastener hole 58 preferably corresponds to a respective insert fastener hole 60 disposed on the decorative insert 30. Preferably, the insert bay 38 includes a plurality of bay fastener holes 58 in order to properly and firmly secure the decorative insert 30 to the vertical support member 18. In this regard, it is also contemplated that the truck rack 10 may further include a fastener 62, such as a bolt or screw that may be disposed through the bay fastener hole 58 and the insert fastener hole 60 to secure at least a portion of the insert 30 to the insert bay 38. The use of such fasteners 62, as well as the incorporation of two sets of bay and insert fastener holes 58, 60 (illustrated in FIGS. 1 and 3-8a) provide easy and sturdy assembly.

Although the insert bay 38 preferably utilizes discrete fasteners 62 such as those mentioned above, it is also contemplated that clamps, adhesives, magnetic elements, pressure fit elements and designs, or other such fasteners 62 may be utilized to secure the insert 30 to the vertical support member 18 as discussed herein. Preferably, the use of such fasteners 62 allows the insert 30 to be removably mountable to the insert bay 38. Thus, welding, and other semi-permanent joining techniques and fasteners are preferably avoided; however, such semi-permanent and permanent joining techniques may be useful in reference to the actual assembly of the rack 10 other than securing the insert 30 thereto. Additionally, such fasteners 62 should not only be durable and able to withstand the rigors of abuse, but should preferably be easily unfastened or removed.

As illustrated in FIGS. 4-8a, the insert 30 may be variously configured and customized to include desirable structural patterns 64. The insert 30, as shown, may be substantially planar; however, it is also contemplated that an insert 30 may include a three-dimensional pattern, such as a relief or stamp. In this regard, the artistic quality and character of the insert 30 may be limited only by imagination.

Furthermore, the decorative face 36 may also be colored or include a textured surface. In addition, the pattern 64 may be centrally disposed on the decorative face 36 on the insert 30. However, the pattern 64 may also be positioned at any location on the decorative face 36 of the insert 30. Finally, the pattern 64 may also be a cutout 66 from the insert 30, as shown in FIGS. 4, 5, 5a, 6, 6a, 8, and 8a. These cutouts 66 merely represent a few of the possible patterns 64 that may be used on the decorative face 36 of the inserts 30.

Although it is contemplated that the decorative insert 30 be made of a metal, the decorative insert 30 may also be made of other materials such as plastic. For example, the decorative insert 30 may be made of a clear plastic material and incorporate other unique designs thereon. Additionally, by manipulating the material used for the decorative insert 30, other aesthetic properties may be achieved, such as having a wider variety of colors, finishes, textures, and patterns.

Referring now to FIGS. 5-8a, the decorative insert 30 is preferably mounted on the inner surface 40 of the insert bay 38 with the decorative face 36 being exposed through the aperture 52 of the insert bay 38. The decorative insert 30 may be manufactured in a variety of standard sizes in order to allow for the interchangeability of the inserts 30 by the owner. Further, although it is illustrated that the peripheral edge 34 of the decorative insert 30 may extend beyond the interior perimeter edge 54 of the aperture 52 at all locations around the aperture 52, the insert 30 may also be configured such that only selected portions of the peripheral edge 34 of the insert 30 extend beyond the interior perimeter edge 54 of the aperture 52, particularly where the insert 30 is secured to the insert bay 38.

It is also contemplated that modification of the shape of the peripheral edge 34 with respect to the interior perimeter edge 54, may accomplish other designs and functions for the insert 30 and/or insert bay 38. For example, the insert 30 may be shaped to bulge outwardly through the aperture 52 in order to form an air intake duct. In other uses, it is contemplated that the insert 30 may advantageously use passing air to create whistling noises and the like. Further, the configuration of the insert 30 and/or the insert bay 38 may be modified to enhance the air flow through the cargo bed 14. Other problems and considerations may arise wherein the interaction of the passing air with the insert 30 and/or the insert bay 38 may be optimized to provide for beneficial results. Thus, various other functional designs may be made by altering the shape and configuration of the insert 30.

Finally, as will be appreciated by one of skill in the art, the exemplary embodiments presented herein provide only a sampling of the various modifications which may be made to embodiments of the present invention. In effect, the customizable nature of the insert 30 and the truck rack 10, in general, permits the owner to modify the appearance of their vehicle 16 in a very convenient and easy manner. The inserts 30 of embodiments of the present invention should preferably not require significant time or equipment to be removed or installed. Thus, the owner may easily be enabled to not only install the truck rack 10, as described in the above-mentioned patent applications, but to also easily mount and interchange the inserts 30 according to his or her own will and pleasure.

The above description is given by way of example, and not limitation. Given the above disclosure, one skilled in the art could devise variations that are within the scope and spirit of the invention disclosed herein, including various ways of manufacturing, using, designing, or installing the rack 10, vertical support members 18, and/or inserts 30. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A decorative insert for a customizable truck rack, the rack including opposing vertical support members and a horizontal crossbar member, the vertical support members defining bottom and top ends, the bottom ends being attachable to opposing side walls of a cargo bed of a vehicle, the horizontal crossbar member being attachable to the top ends of the vertical support members, the vertical support members each including an insert bay, the insert comprising:
a sheet defining a peripheral edge and a decorative face, at least a portion of the peripheral edge being cooperatively securable to the insert bay of the vertical member, the sheet being positionable with the decorative face being exposed.

2. The insert of claim 1 wherein the insert is substantially planar.

3. The insert of claim 1 wherein the decorative face of the insert includes a structural pattern.

4. The insert of claim 3 wherein the pattern is centrally disposed on the decorative face of the insert.

5. The insert of claim 3 wherein the pattern is a cut-out from the insert.

6. The insert of claim 1 wherein the insert may be replaceably mounted to the insert bay of the vertical support.

7. The insert of claim 1 wherein the insert is securable adjacent an inner surface of the insert bay with the decorative face being exposed through an aperture of the insert bay.

8. The insert of claim 1 wherein the insert further includes at least one insert fastener hole corresponding to a respective bay fastener hole, the insert fastener hole being sized and configured to receive a fastener therethrough for securing at least a portion of the insert to the insert bay.

9. A vertical support member for a customizable truck rack, the vertical support member comprising:
a body defining bottom and top ends, the bottom end being attachable to opposing side walls of a cargo bed of a vehicle, the top end being attachable to a horizontal crossbar member; and
an insert bay being disposed in the body of the vertical support member, the insert bay being sized and configured to receive at least a portion of the decorative insert for cooperatively securing the insert thereto.

10. The vertical support member of claim 9 wherein the insert bay is sized and configured to receive the entire decorative insert secured therein.

11. The vertical support member of claim 9 wherein the insert bay includes an aperture, the aperture defining an interior perimeter edge.

12. The vertical support member of claim 11 wherein the insert bay defines inner and outer surfaces, the insert bay being configured to secure the decorative insert adjacent the inner surface with a decorative face of the insert being exposed through the aperture.

13. The vertical support member of claim 11 further comprising a gasket element being disposable about the interior perimeter edge of the aperture of the insert bay.

14. The vertical support member of claim 9 wherein the insert bay further includes at least one bay fastener hole, the bay fastener hole being sized and configured to receive a fastener therethrough for securing at least a portion of the insert to the insert bay.

15. A customizable truck rack being mountable to a cargo bed of a vehicle, the cargo bed including opposing side walls, the rack comprising:
at least one decorative insert defining a peripheral edge and including a decorative face;
opposing vertical members defining bottom and top ends, the bottom ends being attachable to the side walls of the cargo bed, the vertical members each including an insert bay being sized and configured to secure at least a portion of the peripheral edge of the insert thereto with at least a portion of the decorative face of the insert being exposed; and
a horizontal member being attachable to the top ends of the vertical members.

16. The rack of claim 15 wherein the decorative face of the insert includes a structural pattern.

17. The rack of claim 16 wherein the pattern is centrally disposed on the decorative face of the insert.

18. The rack of claim 17 wherein the pattern on the decorative face is a cut-out from the insert.

19. The rack of claim 15 wherein the vertical support defines an inner surface and the insert bay includes an aperture, the insert being securable adjacent the inner surface with the decorative face being exposed through the aperture of the insert bay.

20. The insert of claim 15 wherein the insert bay includes at least one bay fastener hole and the insert further includes at least one insert fastener hole corresponding to a respective bay fastener hole, the insert and bay fastener holes being sized and configured to receive a fastener therethrough for securing at least a portion of the insert to the insert bay.
